(19) United States
(12) Patent Application Publication
(10) Pub. No.: US 2008/0286603 A1
(43) Pub. Date: Nov. 20, 2008

(54) Steel Sheet for Hot Press Forming Having Excellent Heat Treatment and Impact Property, Hot Press Parts Made of It and the Method for Manufacturing Thereof

(75) Inventors: Jin-Keun Oh, Kyungsangbook-do (KR); Dae-Chul Bae, Kyungsangbook-do (KR); Seong-Ju Kim, Kyungsangbook-do (KR); Kwang-Geun Chin, Kyungsangbook-do (KR); Jae-Ryung Lee, Kyungsangbook-do (KR); Young-Jun Park, Kyungsangbook-do (KR)

Correspondence Address: MCDERMOTT WILL & EMERY LLP, 18191 VON KARMAN AVE., SUITE 500, IRVINE, CA, 92612-7108, US

(73) Assignee: POSCO, Kyungsangbook-do (KR)

(21) Appl. No.: 12/092,342

(22) PCT Filed: Dec. 1, 2006
(86) PCT No.: PCT/KR06/05155

§ 371 Date: May 1, 2008

(30) Foreign Application Priority Data
Dec. 1, 2005 (KR) 10-2005-0116556
Dec. 19, 2005 (KR) 10-2005-0125207
Dec. 23, 2005 (KR) 10-2005-0129100

(51) Int. Cl. B32B 15/18; C23C 2/02; C21D 6/04; C23C 2/26; C21D 8/00

(52) U.S. Cl. 428/684; 428/544; 148/531; 148/578; 148/654; 148/517; 148/533; 148/603; 148/651

(57) ABSTRACT

Disclosed is a steel sheet that exhibits an ultra-high strength after hot press forming followed by rapid cooling, and an enhanced yield strength after painting. The steel sheet has a composition comprising 0.1% to 0.5% by weight of C, 0.01% to 1.0% by weight of Si, 0.5% to 4.0% by weight of Mn, 0.1% by weight or less of P, 0.03% by weight or less of S, 0.1% by weight of soluble Al, 0.01% to 0.1% by weight of N, 0.3% by weight or less of W, and the balance Fe and other inevitable impurities. Further disclosed are a hot-pressed part made of the steel sheet and a method for manufacturing the hot-pressed part. The hot-pressed part achieves a high increment in yield strength after heat treatment for painting while ensuring an ultra-high tensile strength. Furthermore, the hot-pressed part exhibits superior adhesion to a coating layer, good surface appearance and improved corrosion resistance after painting.

### TECHNICAL FIELD

The present invention relates to a steel sheet for hot press forming that is mainly used in the manufacture of structural parts and reinforcements of automobile bodies, a method for producing the steel sheet, a hot-pressed part made of the steel sheet, and a method for manufacturing the hot-pressed part. More specifically, the present invention relates to a steel sheet for hot press forming that exhibits an ultra-high strength after hot press forming and an increased yield strength after painting, a method for producing the steel sheet, a hot-pressed part made of the steel sheet, and a method for manufacturing the hot-pressed part.

### BACKGROUND ART

In recent years, the regulations associated with the lives and safety of automobile passengers have been increasingly stringent. Under such circumstances, studies to reduce the weight of automobile bodies and to develop high-strength steel sheets for the lightweight automobile bodies are now being actively undertaken to improve the impact resistance of the automobile bodies. However, improvement in the strength of steel sheets for use in automobiles leads to a considerable deterioration in the formability of the steel sheets.

In attempts to solve this problem, several proposals have been made. For example, Korean Patent Laid-open No. 2005-062194 proposes a method for producing a highly formable, high-strength steel sheet. A steel sheet produced by this method is a trans-formation-induced plasticity (TRIP) steel sheet using the martensite transformation of residual austenite and may have a tensile strength on the order of 980 MPa.

However, addition of an element, such as C or Mn, is required to achieve a tensile strength higher than 980 MPa, which incurs an increase in production cost. In addition, during press forming of an ultra-high-strength steel sheet, some problems, such as inferior shape retainability and damage to molds, are encountered during the press forming due to the high strength of the steel sheet.

To improve these problems, various proposals have hitherto been made as to techniques utilizing hot press forming. For example, Korean Patent Laid-open No. 2003-049731 proposes a method for producing an final product from cold-rolled steel sheet by heat-treating and press-forming a steel sheet in an austenite single-phase region using low strength and high workability of the steel sheet prior to the heat treatment, followed by rapid cooling in a mold. Further, Japanese Unexamined Patent Publication No. 2005-126733 discloses the production of a steel sheet with superior high-temperature workability for hot press, which is characterized by the addition of Mo, Nb or a combination thereof.

The prior art methods stress the importance of improved tensile strength of steel sheets after hot press forming, but have technical limitations in achieving excellent impact properties of steel sheets due to increased yield strength of the steel sheets after painting.

In the meanwhile, Japanese Unexamined Patent Publication No. 2003-034854 proposes a hot-pressed part having a Fe—Al-based coating film containing Cr and Mn in an amount of more than 0.1% with respect to the total weight of the coating film. Mn or Cr functions to induce a change in the texture of the Fe—Al-based coating film, resulting in an improvement in corrosion resistance. The addition of Cr for the formation of the coating film, however, increases the viscosity of the surface of a coating solution and makes the concentration of the coating solution difficult to control at a constant level, causing the problem that a common coating operation cannot be carried out at a high speed.

### DISCLOSURE OF INVENTION

### Technical Problem

The present invention provides a steel sheet for hot press forming that exhibits a high tensile strength by rapid cooling after heat treatment and achieves a high increment in yield strength after heat treatment for painting. Based on these advantages, excellent impact properties of the steel sheet according to the present invention are attained. In addition, the steel sheet according to the present invention advantageously exhibits good adhesion to a coating layer. Furthermore, other advantages of the steel sheet according to the present invention are good surface appearance and superior corrosion resistance after painting.

### Technical Solution

The present invention has been made to solve the foregoing problems of the prior art and therefore an aspect of the present invention is to provide a steel sheet which has a composition comprising 0.1% to 0.5% by weight of carbon (C), 0.01% to 1.0% by weight of silicon (Si), 0.5% to 4.0% by weight of manganese (Mn), 0.1% by weight or less of phosphorus (P), 0.03% by weight or less of sulfur (S), 0.1% by weight of soluble aluminum (Al), 0.01% to 0.1% by weight of nitrogen (N), 0.3% by weight or less of tungsten (W), and the balance iron (Fe) and other inevitable impurities.

The steel sheet of the present invention may be a hot-rolled steel sheet, a cold-rolled steel sheet, or a steel sheet having a layer coated with aluminum, galvanized layer or galvannealed layer.

In an embodiment of the present invention, the steel sheet has a layer coated with aluminum which contains Si, in a coating weight of 40 to 80 g/m² per side.

In a further embodiment of the present invention, the steel sheet may have a layer coated with galvanized layer or galvannealed layer formed on the surface and may contain 1.0 to 4.0% by weight of Mn.

In another embodiment of the present invention, the composition of the steel sheet may further comprise at least one element selected from the group consisting of a) at least one element selected from Mo and Cr in an amount of 0.01% to 2.0% by weight, b) at least one element selected from Ti, Nb and V in an amount of 0.001% to 0.1% by weight, c) at least one element selected from Cu in an amount of 0.005% to 1.0% by weight and Ni in an amount of 0.005% to 2.0% by weight, and d) B in an amount of 0.0001% to 0.01% by weight.

Another aspect of the present invention is to provide a method for producing a zinc-coated (galvanized) steel sheet, comprising: reheating a steel slab satisfying the steel composition defined above to 1,100° C. to 1,300° C., subjecting the reheated steel slab to hot finish rolling at a temperature not lower than the Ar₃ transformation point but not higher than 1,000° C., and coiling the hot-rolled steel sheet at 500° C. to 750° C.; pickling the coiled hot-rolled steel sheet and cold rolling the pickled hot-rolled steel sheet; and hot-dip galvanizing the cold-rolled steel sheet in the temperature range of 450° C. to 500° C. for 10 seconds or less. The method may further comprise alloying the galvanized cold-rolled steel sheet in the temperature range of 440° C. to 580° C. for 30 seconds or less after the galvanization. The method may further comprise continuously annealing the cold-rolled steel sheet at a temperature of 750° C. to 900° C. prior to the hot-dip galvanization.

Another aspect of the present invention is to provide a hot-pressed part which has a steel microstructure composed of 80% or more of a martensitic structure and has the steel composition defined above.

In an embodiment of the present invention, the hot-pressed part may have a layer coated with aluminum, galvanized layer or galvannealed layer.

In a further embodiment of the present invention, the aluminum coating layer contains 4.5% to 8.4% of Si, 39% to 55% of Fe and the balance Al.

In another embodiment of the present invention, the hot-pressed part has a yield strength variation (ΔYS) before and after painting of 100 MPa or more and preferably 120 MPa or more.

Yet another aspect of the present invention is to provide a method for manufacturing a hot-pressed part by hot-press forming a steel sheet satisfying the steel composition defined above and rapidly cooling the hot-pressed steel sheet at a rate of 10° C./sec to 500° C./sec to allow the steel sheet to have a martensitic structure fraction of 80% or more.

The steel sheet may be a hot-rolled steel sheet, a cold-rolled steel sheet or an aluminum-coated steel sheet. The hot press forming is preferably performed by heating the steel sheet in the temperature range of 800° C. to 1,000° C. at a rate of 1° C./sec to 100° C./sec, and forming the hot steel sheet while maintaining the temperature range for 10 to 1,000 seconds.

The aluminum-coated steel sheet has a layer coated with aluminum in a coating weight of 40 to 80 g/m² per side and containing Si.

The steel sheet may be a galvanized steel sheet or a steel sheet coated with a galvannealed layer. At this time, the steel sheet preferably contains 1.0% to 4.0% of Mn. The hot press forming is performed by heating the steel sheet in the temperature range of 700° C. to 950° C. at a rate of 1° C./sec to 100° C./sec and forming the hot steel sheet while maintaining the temperature range for 10 to 1,000 seconds. The zinc-coating is performed by hot-dip galvanizing the cold-rolled steel sheet in the temperature range of 450° C. to 500° C. for 10 seconds or less. The galvannealed steel is performed by hot-dip galvanizing the cold-rolled steel sheet in the temperature range of 450° C. to 500° C. for 10 seconds or less and alloying the galvanized cold-rolled steel sheet in the temperature range of 440° C. to 580° C. for 30 seconds or less.

In an embodiment of the present invention, the steel sheet is produced by reheating a steel slab to 1,100° C. to 1,300° C., subjecting the reheated steel slab to hot finish rolling at a temperature not lower than the Ar₃ transformation point but not higher than 1,000° C., and coiling the hot-rolled steel sheet at 500° C. to 750° C.; and pickling the coiled hot-rolled steel sheet and cold rolling the pickled hot-rolled steel sheet. The cold-rolled steel sheet may be continuously annealed at 700° C. to 900° C.

### ADVANTAGEOUS EFFECTS

The steel sheet of the present invention has an ultra-high strength and an enhanced yield strength after painting. In addition, the steel sheet of the present invention exhibits improved surface treatment properties. Therefore, the steel sheet of the present invention can be used in the manufacture of structural parts and reinforcements of automobiles, thereby reducing the weight of automobile bodies and achieving greatly improved impact properties.

### BEST MODE FOR CARRYING OUT THE INVENTION

Exemplary embodiments of the present invention will now be described in detail.

The steel of the present invention exhibits characteristics of heat treatment-hardenable steels. The term ‘heat treatment-hardenable’ means that a steel sheet has a low-temperature transformation phase at the time of cooling during heat treatment, thus strengthening the steel sheet. The steel sheet for hot press forming according to the present invention can be used in the field of heat treatment-hardenable steels because a representative example of heat treatment-hardenable steels is a high-strength steel for hot press forming that is produced by forming a steel in a hot press and rapidly cooling the hot-pressed steel. The term ‘hot-pressed part’ as used herein refers to a high-strength part manufactured by forming a steel sheet into a desired shape, followed by heat treatment. According to an embodiment of the present invention, there is provided a high-strength hot-pressed part manufactured by forming a steel sheet in a hot press and rapidly cooling the hot-pressed steel. It is to be understood that the hot-pressed part includes high-strength parts manufactured by forming the steel sheet of the present invention into a desired shape in a warm press or at room temperature, followed by heat treatment. The hot-pressed part can be used in various applications, for example, structural parts and reinforcements of automobiles, which utilize the physical properties of the steel according to the present invention.

The present invention was accomplished in the course of research to improve the mechanical properties and surface characteristics of steels for hot press forming.

(1) Mechanical Properties

The steel sheet of the present invention is characterized in that tungsten (W) is used as an element for guaranteeing superior heat treatment-hardenability of the steel sheet to achieve ultra-high strength of the steel sheet. In addition, the present invention was accomplished based on the fact that when a tungsten (W)-added steel is designed to have a high-nitrogen component system, the yield strength of the steel is drastically increased after painting, and as a result, superior impact resistance of the steel is achieved.

(2) Surface Characteristics

According to a further embodiment, the steel of the present invention may be a hot-rolled steel sheet or a cold-rolled steel sheet, which may be optionally coated. The coating may be performed by zinc coating(galvanization) that is mainly applied to the manufacture of automobile materials, galvannealed steel, or aluminum coating that is mainly applied to the production of steel sheets for hot press forming.

According to another embodiment of the present invention, the steel sheet is galvanized and subjected to hot press forming at a relatively low temperature to improve the adhesion to a coating layer. The adhesiveness of the steel sheet is deteriorated with increasing temperature during the hot press forming, which results in poor corrosion resistance. Accordingly, a low temperature during the hot press forming leads to an improvement in the adhesion of the steel sheet to the coating layer. Thus, it is important to allow the steel sheet to have a sufficient strength. According to another embodiment of the present invention, the steel sheet may have improved adhesion to a coating layer and a sufficiently high strength by galvanizing the steel sheet and lowering the temperature necessary for hot press forming of the galvanized steel sheet.

In addition, the heat treatment-hardenable steel of the present invention can be coated with aluminum. According to another embodiment of the present invention, the surface characteristics of a W-added steel having a high-nitrogen component system are improved by controlling the content of Si in the surface of an Al—Si—Fe-based coating film. That is, when a coating film is formed on the steel sheet using an aluminum coating solution containing Si, the surface characteristics of the steel sheet are improved due to the Si content in the surface of the coating film even without the addition of any alloying element.

The composition of the steel according to the present invention will be explained. As used herein, percentages (%) of components of the composition are weight percentages.

Carbon (C) is preferably present in an amount of 0.1% to 0.5%.

C is an essential element for enhancing the strength of the steel sheet. C is preferably added in an amount of 0.1% or more to form a hard phase, such as austenite or martensite, and to achieve an ultra-high strength. When the C content is below 0.1%, a desired strength of the steel sheet is not attained despite heat treatment in an austenite single-phase region. Meanwhile, when the C content exceeds 0.5%, there is a great possibility that the toughness and weldability of the steel sheet will be deteriorated. Moreover, a C content exceeding 0.5% makes the welding of the steel sheet difficult during pickling of a hot-rolled steel sheet and rolling, and causes undesirable problems in that the strength of the steel sheet is considerably increased during annealing and coating and the threading performance of the steel sheet is worsened.

Silicon (Si) is preferably present in an amount of 0.01% to 1.0%.

Si is a solid solution strengthening element and contributes to an increase in the strength of the steel sheet. In the case where the Si content is less than 0.01%, there is a difficulty in removing surface scales of a hot-rolled steel sheet. Meanwhile, in the case where the Si content is more than 1.0%, the production cost of the steel sheet may be increased. A more preferred Si content is in the range of 0.051% to 0.5%, but is not limited to this range.

Manganese (Mn) is preferably added in an amount of 0.5% to 4.0%.

Mn, which is a solid solution strengthening element, greatly contributes to an increase in the strength of the steel sheet as well as plays an important role in retarding the transformation from austenite to ferrite. When the Mn content is less than 0.5%, a high temperature is required to heat-treat the steel sheet in an austenite single-phase region. This high temperature accelerates the oxidation of the steel sheet, which adversely affect the corrosion resistance of the steel sheet although the steel sheet is coated. In addition, it is difficult to attain an intended ultra-high strength of the steel sheet by heat treatment of the steel sheet in a ferrite-austenite two-phase region. Meanwhile, when the Mn content is more than 4.0%, there are dangers that the steel sheet suffers from poor weldability and hot rolling characteristics. According to another embodiment of the present invention, when it is intended to galvanize the steel sheet and lower the temperature necessary for hot press forming of the galvanized steel sheet, the Mn content is preferably limited to the range of 1.0% to 4.0% and more preferably the range of 2.0% to 4.0%. Mn is an element that is useful in lowering the Ac₃ temperature. A higher Mn content is advantageous in lowering the temperature necessary for hot press forming.

Phosphorus (P) is preferably present in an amount of 0.1% or less.

P is an effective element for enhancing steel, but may deteriorate the workability of the steel when it is added in an excess amount. Accordingly, the P content is preferably limited to 0.1% or less.

Sulfer(S) is preferably present in an amount of 0.03% or less. S is an impurity element contained in steel. Due to the possibility of impairing the ductility and weldability of the steel sheet, the S content is preferably limited to 0.03% or less.

Soluble aluminum (Al) is preferably present in an amount of 0.1% or less.

Soluble Al is added to deoxidize steel. To this end, the Al content is adjusted to 0.1% or less. When the Al content exceeds 0.1%, inclusions, such as alumina, are excessively formed to form AlN, resulting in a decrease in the amount of dissolved nitrogen (N). Therefore, there is a slight increment in the yield strength of the steel sheet.

Nitrogen (N) is preferably present in an amount of 0.01% to 0.1%.

N is a very important component of the steel sheet according to the present invention. N is a solid solution strengthening element and bind to nitride-forming elements to increase the yield strength of the steel sheet. N is added in an amount sufficient to improve the heat treatment properties and increase the yield strength after painting. A sufficient amount of N remains in the form of dissolved N within crystal grains before painting, and thereafter, impedes dislocation movement after painting to increase the yield point, which is a primary cause of a rapid increase in the yield strength of the steel sheet. Such effects are not expected when the N content is less than 0.01%. On the other hand, a N content exceeding 0.1% makes it difficult to dissolve and cast the steel sheet and unfavorably causes a deterioration in the workability of the steel sheet and occurrence of blow holes during welding. The N content is preferably limited to the range of 0.011% to 0.1% and more preferably the range of 0.02% to 0.1%.

Tungsten (W) is preferably present in an amount of 0.3% or less.

W is an element for improving the heat treatment-hardenability of the steel sheet, and is a very important element because W-containing precipitates advantageously act to guarantee a sufficient strength of the steel sheet. Such effects saturate and a considerable production cost is incurred if the W content exceeds 0.3%. Accordingly, the W content is preferably limited to 0.001% or less, more preferably 0.001% to 0.3%, and most preferably 0.001% to 0.1%.

The composition of the steel sheet according to the present invention may further comprise at least one element selected from Mo, Cr, Ti, Nb, V, Cu, Ni, and B.

Mo and Cr are elements for improving the hardenability of the steel sheet. Ti, Nb and V are elements for enhancing the formation of precipitates in the steel sheet. Cu and Ni are elements for enhancing the strength of the steel sheet. B is also an element for improving the hardenability of the steel sheet. A detailed explanation of these elements will be provided below.

At least one element selected from Mo and Cr is preferably present in an amount of 0.01% to 2.0%.

Mo and Cr serve to improve the hardenability of the steel sheet and increase the toughness of the heat treatment type steel sheet. Accordingly, the addition of at least one element selected from Mo and Cr to the steel sheet, which is characterized by high absorption of impact energy, is very effective. In addition, an improvement in the hard-enability due to the addition of at least one element selected from Mo and Cr enables prevention of a deterioration in the strength of portions of the steel sheet that are not in direct contact with a mold during high-temperature forming. For this purpose, Mo or Cr is preferably added in an amount of 0.01% or more. The hardenability of the steel sheet is not satisfactorily improved despite the addition of an increased amount of Mo or Cr, which causes an unnecessary increase in the production cost of the steel sheet. Accordingly, the amount Mo or Cr added is preferably limited to 2.0% or less. A more preferred content of Mo or Cr is preferably between 0.01% and 2.0% and more preferably between 0.01% and 0.5%.

At least one element selected from Ti, Nb and V is preferably present in an amount of 0.001% to 0.1%.

Ti, Nb and V are elements added to increase the strength of the steel sheet, decrease the diameter of particles present in the steel sheet and improve the heat treatment properties of the steel sheet. Such effects are not sufficiently exhibited if the content of at least one element selected from Ti, Nb and V is less than 0.001%. Meanwhile, a considerable production cost is incurred and desired strength and yield strength are not attained due to the formation of excessive amounts of coal briquettes and nitrides if the content of the element exceeds 0.1%.

At least one element selected from Cu in an amount of 0.005% to 1.0% by weight and Ni in an amount of 0.005% to 2.0% by weight is preferably present in the steel sheet.

Cu is an element acting to form fine Cu precipitates to improve the strength of the steel sheet. A Cu content of less than 0.005% results in an insufficient strength of the steel sheet. A Cu content of more than 1.0% results in a deterioration in the workability of the steel sheet.

Ni is an element for increasing the strength and improving the heat treatment properties of the steel sheet. To this end, the Ni content is preferably limited to 0.005% or less. If the Ni content exceeds 2.0%, the production cost of the steel sheet is increased and the workability of the steel sheet is undesirably deteriorated.

B is preferably present in an amount of 0.0001% to 0.01%.

B is a highly hardenable element. Despite the presence of a slight amount of B, a high strength of the heat-treated steel can be guaranteed. When the B content is not lower than 0.0001%, sufficient hardenability of the steel sheet can be attained. Despite the addition of an increased amount of B, the hot workability of the steel sheet may be undesirably deteriorated without significant improvement in the hardenability of the steel sheet.

According to an exemplary embodiment, the steel sheet for hot press forming according to the present invention has a composition comprising the components present in the respective amounts defined above and the balance Fe and other inevitable impurities. If necessary, other alloying elements may be added to the composition of the steel sheet. Although not mentioned in the embodiments of the present invention, it should be understood that other alloying elements are not excluded from the composition of the steel sheet according to the present invention.

If needed, the steel sheet of the present invention may have various shapes. Various coating layers may be applied to the steel sheet of the present invention. For example, the steel sheet of the present invention may be a hot-rolled steel sheet, a cold-rolled steel sheet, or a cold-rolled annealed steel sheet. Also, the steel sheet of the present invention may be galvanized steel sheet, galvannealed steel sheet or a steel sheet coated with aluminum.

As exemplary embodiments of the present invention, respective methods for producing the hot-rolled steel sheet, the cold-rolled steel sheet and the coated steel sheet will be explained below.

Hot Rolling

First, a steel slab is preferably reheated to 1,100° C. to 1,300° C. At a reheating temperature lower than 1,100° C., the microstructure of the steel sheet becomes non-uniform and the re-dissolution of at least one element selected from alloying elements, such as Ti and Nb, is insufficient. Meanwhile, at a reheating temperature higher than 1,300° C., the microstructure of the steel sheet tends to be coarse and there is a high possibility that problems will arise during production of the steel sheet.

Then, the reheated steel slab is subjected to hot finish rolling at a temperature not lower than the Ar₃ transformation point but not higher than 1,000° C. If the hot finish rolling is performed at a temperature lower than the Ar₃ transformation point, there is a high possibility that the resistance to hot deformation may be steeply increased. Meanwhile, if the hot finish rolling is performed at a temperature higher than 1,000° C., too thick oxide scales are liable to form and the steel sheet tends to be coarse.

Subsequently, the hot-rolled steel sheet is preferably coiled at 500° C. to 750° C. An excess of martensite or bainite is formed at a coiling temperature lower than 500° C., resulting in an excessive increase in the strength of the hot-rolled steel sheet. The excessively increased strength acts as a load during subsequent cold rolling for the production of a cold-rolled steel sheet to cause problems, such as poor appearance. Meanwhile, an excess amount of precipitates may become coarse at a coiling temperature higher than 750° C.

If needed, the hot-rolled steel sheet may be subjected to cold rolling to produce a cold-rolled steel sheet.

Cold Rolling

The coiled hot-rolled steel sheet is pickled and cold-rolled. According to an embodiment of the present invention, the cold rolling is preferably performed at a reduction rate of 30% to 80%. When the cold rolling reduction rate is lower than 30%, it is difficult to attain a desired thickness and to correct the shape of the steel sheet. Meanwhile, when the cold rolling reduction rate is higher than 80%, there is a high possibility that cracks may occur at edges of the steel sheet and a load during the cold rolling may be induced.

If needed, the cold-rolled steel sheet may be subjected to annealing.

Annealing

The cold-rolled steel sheet is continuously annealed at a temperature of 750° C. to 900° C. An annealing temperature lower than 750° C. does not sufficient workability of the cold-rolled steel sheet. Meanwhile, an annealing temperature higher than 900° C. increases the possibility that the production cost may be increased and the surface quality may be degraded.

Coating

The hot-rolled steel sheet, the cold-rolled steel sheet or the annealed cold-rolled steel sheet (hereinafter, referred to simply as a ‘steel sheet’) may be coated as required. According to an embodiment of the present invention, the steel sheet may be galvanized steel sheet, galvannealed steel sheet or a steel sheet coated with a aluminum. Processes for the coating are not particularly limited, and examples thereof include hot dipping, electroplating, vacuum evaporation, and cladding. Hot dipping is preferred in view of productivity. The most preferred coating process will now be explained, but the present invention is not necessarily limited thereto.

Zinc Coating(Galvanization)

The steel sheet is hot-dip galvanized. It is preferred that the galvanization be performed at a temperature of 450° C. to 500° C. for 10 seconds. When the hot dipping is performed at a temperature lower than 450° C., a small amount of zinc may be coated. Meanwhile, when the hot dipping is performed at a temperature higher than 500° C., an excessively large amount of zinc may be coated. When the hot dipping is performed for a time longer than 10 seconds, an excessively large amount of zinc may be coated.

Thereafter, the galvanized cold-rolled steel sheet may be cooled to room temperature to produce a galvanized steel sheet, and optionally, the galvanized steel sheet may be subjected to alloying heat treatment to produce an galvannealed steel sheet. The galvannealed steel sheet may be subjected to alloying heat treatment in the temperature range of 440° C. to 580° C. and preferably 480° C. to 540° C. for 30 seconds or less. The alloying heat treatment is conducted to alloy the hot-dipped galvanized layer during the hot-dip galvanization. When the alloying heat treatment is conducted at a temperature lower than 440° C., the galvanized steel sheet may be unalloyed. Meanwhile, when the alloying heat treatment is conducted at a temperature higher than 580° C., may be over alloyed.

Aluminum Coating

Aluminum coating is generally performed using an Al coating solution containing Si. The Si content of the Al coating solution is in the range of about 7% to about 12%. The Al coating solution contains inevitable impurities, such as Fe.

According to an embodiment of the present invention, the aluminum-coated steel sheet has a layer coated with aluminum in a coating weight of 40 g/m² to 80 g/m² per side and containing Si. Better surface characteristics after hot press forming are obtained due to the presence of the aluminum coating layer. The Si content of the aluminum coating layer varies depending on the processing factors, such as the thickness of the coating layer. For example, when the aluminum coating is conducted in an Al coating solution containing 7% to 12% of Si and the Al coating layer has a coating weight of 40 g/m² to 80 g/m² per side, the Si content of the coating layer is in the range of about 5% to about 12%. Importantly, when the aluminum coating layer has a coating weight of 40 g/m² to 80 g/m² per side and contains Si, the content of Si in an Al—Si—Fe coating film formed by subsequent hot press forming is between about 4.5% and about 8.4%, at which better surface characteristics is achieved.

The present invention provides a hot-pressed part. The hot-pressed part of the present invention is manufactured by hot press forming the hot-rolled steel sheet, the cold-rolled steel sheet or the coated steel sheet, followed by rapid cooling. The heat treatment-hardenable steel sheet of the present invention is subjected to hot press forming, and optionally heat-treated to manufacture an ultra-high strength part. There is no particular restriction as to the hot press forming and the heat treatment.

In an embodiment of the present invention, the fraction of a martensitic structure in the hot-pressed part is preferably 80% or more, at which ultra-high strength of the hot-pressed part is attained. A martensite single-phase structure is also preferred. For example, the microstructure of the hot-pressed part has a martensite fraction of 80% or more and the remaining fraction of at least one structure selected from ferrite and bainite. According to an embodiment of the present invention, the hot-pressed part is painted and baked so as to have an increased yield strength of 100 MPa or more and preferably 120 MPa or more.

According to an embodiment of the present invention, the hot-pressed part is subjected to hot press forming. Preferably, the hot-pressed part has a layer coated with aluminum in a coating weight of 40 g/m² to 80 g/m² per side and containing Si. As a result, a Si—Fe—Al coating layer is formed on the surface of the hot-pressed part. When the steel sheet having an Al—Si coating film is subjected to hot press forming, Fe contained in the steel sheet is diffused into the coating film of the coating layer. Si present at the iron base/coating layer interfaces is diffused into the coating film of the coating layer. The surface of the coating film preferably contains 4.5% to 8.4% of Si, 39% to 55% of Fe, and the remaining weight percent of Al and other inevitable impurities. The formation of the coating film leads to an improvement in surface characteristics. The surface area of coating film is within about 5□.

An explanation of a method for manufacturing the hot-pressed part according to the present invention will be given below.

The hot-rolled steel sheet, the cold-rolled steel sheet or the coated steel sheet is subjected to hot press forming, followed by rapid cooling to allow the steel sheet to have a martensitic structure fraction of 80% or more. The rapid cooling is preferably carried out at a rate of about 10° C./sec to about 500° C./sec. When the cooling is carried out at a rate of less than 10° C./sec, it is difficult to obtain a microstructure composed of martensite as a major phase, making it difficult to attain a desired strength. Meanwhile, when the cooling is carried out at a rate of more than 500° C./sec, an excessive investment in manufacturing equipment is required, thus incurring an increase in manufacturing cost, and the strength is not greatly increased as expected. Accordingly, the cooling rate is preferably limited to the range of 10° C./sec to 500° C./sec.

According to an embodiment of the present invention, the hot press forming may be performed by heating the steel sheet in the temperature range of 800° C. to 1,000° C. at a rate of 1° C./sec to 100° C./sec and forming the hot steel sheet in a mold while maintaining the temperature range for 10 seconds to 1,000 seconds. When the heat treatment is conducted at a temperature lower than 800° C., a sufficient amount of austenite is not formed, and as a result, martensite is not sufficiently formed after the hot press forming, which makes it difficult to attain a desired strength. Meanwhile, when the heat treatment is conducted at a temperature higher than 1,000° C., the manufacturing cost is increased and there is a high possibility that austenite may be coarse. When the temperature is increased at a rate lower than 1° C./sec, the manufacturing efficiency tends to decrease. Meanwhile, when the temperature is increased at a rate higher than 100° C./sec, additional manufacturing equipment is needed. When the heat treatment is conducted for a time shorter than 10 seconds, the transformation of austenite is not sufficient. Meanwhile, when the heat treatment is conducted for a time longer than 1,000 seconds, the manufacturing cost is increased and austenite tends to be coarse.

On the other hand, a steel sheet coated with galvanized layer or galvannealed layer is preferably subjected to hot press forming at a temperature of about 700° C. to about 950° C., preferably about 750° C. to about 950° C., and more preferably about 750° C. to about 850° C. Any temperature range may be selected for the hot press forming so long as austenite can be sufficiently formed and the adhesion to the coating layer is not damaged.

### MODE FOR THE INVENTION

To assist the understanding of the present invention, most exemplary embodiments of the present invention are illustrated in the following examples. However, these examples are not to be construed as limiting the scope of the invention.

### EXAMPLES

### Example 1

First, steel slabs having the compositions indicated in Table 1 were prepared. The steel slabs were reheated to a temperature of 1,150° C. to 1,250° C. for one hour, hot-rolled, and coiled. The hot rolling was finished at a temperature of 850° C. to 950° C., and the coiling was conducted at 650° C. Parts of the hot-rolled steel sheets were pickled and cold-rolled at a reduction rate of 50% to produce cold-rolled steel sheets.

The hot-rolled and cold-rolled steel sheets were galvanized by the following procedure. The steel sheets were annealed at 800° C., slowly cooled to 650° C. at a rate of 3° C./sec, cooled to 550° C. at a rate of 7° C./sec, and continuously annealed at an overaging temperature of 460° C. Thereafter, the annealed steel sheets were hot-dip galvanized for 5 seconds to produce hot-dipped galvanized steel sheets.

On the other hand, the hot-rolled steel sheets and the cold-rolled steel sheets were coated with aluminum by the following procedure. The cold-rolled steel sheets were degreased, pretreated, preheated in a non-oxidizing heating furnace at 700° C., and heat-treated in a reducing atmosphere of nitrogen and hydrogen. At this time, the heat treatment was conducted at a maximum temperature of 820° C. The heat-treated steel sheets were cooled and immersed in a coating solution at 680° C. The coating solution was composed of 8.5% of Si, 2.4% of Fe and the balance Al. To form a coating layer to a thickness of 25□ to 30□ per side, gas wiping was performed on the coated steel sheets. Thereafter, a spangle controller was operated to adjust the surface spangle of the Al-coated steel sheets to zero.

Parts of the hot-rolled steel sheets, the cold-rolled steel sheets and the coated steel sheets were subjected to room-temperature forming and post-heat treatment to manufacture respective automobile parts. The remaining parts of the steel sheets were subjected to hot press forming to manufacture respective automobile parts.

The room-temperature forming and the post-heat treatment were performed by V-bending forming the steel sheets at room temperature, increasing the temperature of the formed steel sheets to 800° C. to 950° C. at a rate of 10° C./sec, heating the steel sheets for 5 minutes, and rapidly cooling the hot steel sheets at a rate of 80° C./sec. After the heat treatment, the heat-treated steel sheets were processed into JIS #5 tensile test pieces. The tensile test pieces were boiled in an oil at 170° C. for 20 minutes to simulate the quality of painted structural parts for use in automobiles manufactured using the test pieces. Thereafter, a tensile test on the test pieces was conducted using a universal tensile testing machine.

The hot press forming was performed by heating the steel sheets to 800° C. to 950° C. at a rate of 10° C./sec, heating the steel sheets in the temperature range for 5 minutes, transferring the hot steel sheets into a mold, and processing the hot steel sheets in the mold. Immediately after completion of the processing, the resulting steel sheets were rapidly cooled at a rate of 80° C./sec. Then, the heat-treated steel sheets were cut into JIS #5 tensile test pieces. The test pieces were boiled in an oil at 170° C. for 20 minutes to simulate the quality of painted structural parts for use in automobiles manufactured using the test pieces.

The microstructures of the final products manufactured using the corresponding inventive steels according to the present invention and comparative steels are shown in Table 2. The physical properties of the final products are shown in Table 3.

TABLE 1

| | Chemical components | | | | | | | | | | |
|---|---|---|---|---|---|---|---|---|---|---|---|
| Steel | C | Si | Mn | P | S | Al | N | W | B | Others | Remarks |
| A1 | 0.24 | 0.28 | 1.07 | 0.012 | 0.002 | 0.036 | 0.0172 | 0.051 | 0.0018 | | Inventive |
| | | | | | | | | | | | steel |
| B1 | 0.23 | 0.26 | 1.02 | 0.012 | 0.002 | 0.021 | 0.0136 | 0.050 | 0.0020 | Cr: 0.06, | Inventive |
| | | | | | | | | | | Mo: 0.05 | steel |
| C1 | 0.22 | 0.27 | 2.37 | 0.012 | 0.002 | 0.042 | 0.016 | 0.050 | 0.0008 | Ti: 0.023 | Inventive |
| | | | | | | | | | | V: 0.03 | steel |
| D1 | 0.31 | 0.62 | 0.72 | 0.013 | 0.002 | 0.044 | 0.014 | 0.023 | 0.0011 | Cr: 1.19 | Inventive |
| | | | | | | | | | | Mo: 0.67 | steel |
| | | | | | | | | | | Ni: 0.06 | |
| E1 | 0.23 | 0.216 | 1.228 | 0.011 | 0.003 | 0.050 | 0.0154 | 0.185 | 0.0018 | Nb: 0.02 | Inventive |
| | | | | | | | | | | Cu: 0.05 | steel |
| F1 | 0.062 | 0.112 | 2.519 | 0.011 | 0.002 | 0.036 | 0.0037 | 0.021 | — | Nb: 0.02, | Comparative |
| | | | | | | | | | | Cr: 1.01 | steel |
| G1 | 0.065 | 0.125 | 3.015 | 0.012 | 0.002 | 0.025 | 0.0045 | — | 0.0005 | Cr: 0.97 | Comparative |
| | | | | | | | | | | | steel |
| H1 | 0.150 | 0.229 | 2.504 | 0.011 | 0.003 | 0.040 | 0.0041 | — | 0.0018 | Cr: 0.2, | Comparative |
| | | | | | | | | | | Ti: 0.02 | steel |

TABLE 2

| | |
|---|---|
| | Final |
| Steel/ | microstructure |

| Production | Kind of | Heat | Fraction | |
|---|---|---|---|---|
| conditions | Steel | treatment | of M (%) | Others |
| A1-1 | CR | HPF | 98 | B |
| A1-2 | Al-CR | HPF | 99 | B |
| B1-1 | CR | HPF | 97 | B |
| B1-2 | Al-CR | HPF | 99 | B |
| C1-1 | HR | PHT | 100 | — |
| C1-2 | HR | HPF | 100 | — |
| C1-3 | CR | HPF | 100 | — |
| C1-4 | Al-HR | HPF | 99 | B |
| C1-5 | Zn-CR | HPF | 100 | — |
| C1-6 | Zn-HR | HPF | 100 | — |
| D1-1 | CR | HPF | 100 | — |
| D1-2 | Al-CR | HPF | 100 | — |
| E1-1 | CR | HPF | 99 | B |
| E1-2 | Al-CR | HPF | 99 | B |
| F1-1 | HR | PHT | 30 | F + B |
| F1-2 | HR | HPF | 34 | F + B |
| F1-3 | CR | HPF | 33 | F + B |
| F1-4 | Al-CR | HPF | 35 | F + B |
| F1-5 | Zn-CR | HPF | 37 | F + B |
| F1-6 | Zn-HR | HPF | 34 | F + B |
| G1-1 | CR | HPF | 31 | F + B |
| G1-2 | Al-CR | HPF | 32 | F + B |
| H1-1 | CR | HPF | 71 | F + B |
| H1-2 | Al-CR | HPF | 73 | F + B |

* M: Martensite, B: Bainite F: Ferrite, CR: Cold-rolled steel sheet, HR: Hot-rolled steel sheet, HPF: Hot press forming, PHT: Post Heat Treatment, Al-CR: Al-coated cold-rolled steel sheet, Al-HR: Al-coated Hot-rolled steel sheet, Zn-CR: Zn-coated cold-rolled steel sheet, Zn-HR: Zn-coated Hot-rolled steel sheet,

TABLE 3

| | YS | TS | | ΔYS |
|---|---|---|---|---|
| Steel | (Mpa) | (MPa) | El (%) | (MPs) |
| A1-1 | 973 | 1487 | 7.3 | 193 |
| A1-2 | 982 | 1492 | 7.9 | 186 |
| B1-1 | 1017 | 1506 | 7.6 | 170 |
| B1-2 | 1035 | 1521 | 7.4 | 175 |
| C1-1 | 1025 | 1591 | 7.7 | 147 |
| C1-2 | 1087 | 1597 | 7.2 | 135 |
| C1-3 | 1130 | 1607 | 4.9 | 153 |
| C1-4 | 1125 | 1598 | 5.3 | 145 |
| C1-5 | 1127 | 1601 | 6.5 | 151 |
| C1-6 | 1078 | 1593 | 7.9 | 142 |
| D1-1 | 1202 | 1763 | 7.2 | 136 |
| D1-2 | 1215 | 1798 | 6.5 | 125 |
| E1-1 | 1094 | 1494 | 6.6 | 136 |
| E1-2 | 1105 | 1511 | 6.5 | 144 |
| F1-1 | 896 | 1146 | 9.1 | 56 |
| F1-2 | 912 | 1151 | 8.7 | 51 |
| F1-3 | 941 | 1156 | 7.8 | 35 |
| F1-4 | 925 | 1178 | 7.4 | 41 |
| F1-5 | 936 | 1165 | 7.6 | 40 |
| F1-6 | 905 | 1149 | 9.0 | 58 |
| G1-1 | 901 | 1125 | 6.6 | 54 |
| G1-2 | 915 | 1145 | 6.2 | 36 |
| H1-1 | 1048 | 1497 | 3.6 | 43 |
| H1-2 | 1063 | 1518 | 3.4 | 35 |

As can be seen from the results of Tables 1 to 3, the final products manufactured using the respective hot-rolled steel sheets, cold-rolled steel sheets and coated steel sheets, which were produced using Inventive Steels A1-E1 satisfying the steel composition defined in the present invention, by forming and post-heat treatment or hot press forming showed an ultra-high tensile strength higher than 1,180 MPa. Further, the yield strength variations of the final products before and after painting simulation at 170° C. for 20 minutes were higher than 100 MPa, which indicates that the final products can be used as structural parts and reinforcements of automobile bodies with excellent impact properties.

In contrast, the respective final products manufactured using Comparative Steels F—H, which were outside the steel composition defined in the present invention, did not attain a tensile strength higher than 1,180 MPa or a yield strength variation greater than 100 MPa. Particularly, the final product manufactured using Comparative Steel F whose C and N contents were out of the respective ranges defined in the present invention did not attain the desired fraction of martensite and showed a slight increment in tensile strength and yield strength. These problems were also observed in the final product manufactured using Comparative Steel G whose C, N and W contents were out of the respective ranges defined in the present invention. Further, the final product manufactured using Comparative Steel H whose N and W contents were out of the respective ranges defined in the present invention showed a slight increment in yield strength.

### Example 2

First, steel slabs having the compositions indicated in Table 4 were prepared. The steel slabs were dissolved under vacuum and reheated in a heating furnace at a temperature of 1,150° C. to 1,250° C. for one hour, hot-rolled, and coiled. The hot rolling was finished at a temperature of 850° C. to 950° C., and the coiling was conducted at 650° C. The hot-rolled steel sheets were pickled and cold-rolled at a reduction rate of 50%. The cold-rolled steel sheets were annealed at 800° C. and continuously annealed at an overaging temperature of 400° C.

Thereafter, the annealed steel sheets were heated to 460° C., hot-dip galvanized for 5 seconds, alloyed at 500° C. for 10 seconds to alloy the coating layer, and cooled to room temperature to produce an alloyed hot-dipped galvanized steel sheet. Subsequently, the coated steel sheets were heated to the respective temperatures shown in Table 5 at a rate of 10° C./sec, further heated in the temperature range for 5 minutes, transferred into a mold, and processed in the mold. Immediately after completion of the processing, the resulting steel sheets were rapidly cooled at a rate of 80° C./sec.

Then, the heat-treated steel sheets were cut into JIS #5 tensile test pieces. The adhesion to the coating layer was determined by observing the degree of adhesion between the galvanized layer and each of the steel sheets at a site processed by 90°-bending hot press forming under an optical microscope. The test pieces were painted and boiled in an oil at 170° C. for 20 minutes to simulate the quality of painted structural parts for use in automobiles manufactured using the test pieces.

The microstructures and the physical properties of the final products manufactured using the corresponding inventive steels according to the present invention and comparative steels by hot press forming are shown in Table 5.

TABLE 4

| | Chemical components | | | | | | | | | |
|---|---|---|---|---|---|---|---|---|---|---|
| Steel | C | Si | Mn | P | S | Al | N | W | B | Others |
| A2 | 0.22 | 0.27 | 2.37 | 0.012 | 0.002 | 0.042 | 0.016 | 0.05 | 0.0006 | Ti: 0.023 |
| | | | | | | | | | | Cr: 0.02 |
| B2 | 0.24 | 0.15 | 2.16 | 0.011 | 0.005 | 0.036 | 0.012 | 0.03 | 0.0010 | Nb: 0.015 |
| | | | | | | | | | | Mo: 0.05 |
| C2 | 0.23 | 0.13 | 2.26 | 0.015 | 0.004 | 0.052 | 0.020 | 0.07 | 0.0022 | Cu: 0.05 |
| | | | | | | | | | | Ni: 0.05 |
| D2 | 0.23 | 0.26 | 1.02 | 0.012 | 0.002 | 0.02 | 0.005 | — | 0.0020 | Cr: 0.05 |
| | | | | | | | | | | Mo: 0.05 |
| E2 | 0.07 | 0.133 | 2.98 | 0.012 | 0.002 | 0.016 | 0.004 | — | 0.0017 | Ti: 0.01 |
| | | | | | | | | | | Cr: 1.01 |

TABLE 5

| | | microstructure after | | | | | | | |
|---|---|---|---|---|---|---|---|---|---|
| | | hot press forming | | | | | | | |
| | | Fraction | | | | | | Adhesion | |
| | Heat | of | | | | | | to- | |
| | treatment | martensite | Other | YS | TS | | YS | coating | |
| Steel | Temp. | (%) | structures | (MPa) | (MPa) | El (%) | (MPa) | layer | Remarks |
| A2 | 750 | 96 | Ferrite | 951 | 1568 | 6.5 | 124 | ◯ | Inventive |
| | | | | | | | | | Material 1 |
| A2 | 800 | 99 | Bainite | 1172 | 1651 | 7.9 | 189 | ◯ | Inventive |
| | | | | | | | | | Material 2 |
| B2 | 750 | 94 | Ferrite | 923 | 1532 | 7.2 | 103 | ◯ | Inventive |
| | | | | | | | | | Material 3 |
| B2 | 800 | 98 | Bainite | 1156 | 1621 | 7.4 | 135 | ◯ | Inventive |
| | | | | | | | | | Material 4 |
| C2 | 750 | 95 | Ferrite | 947 | 1575 | 6.9 | 134 | ◯ | Inventive |
| | | | | | | | | | Material 5 |
| C2 | 800 | 99 | Bainite | 1185 | 1673 | 7.5 | 152 | ◯ | Inventive |
| | | | | | | | | | Material 6 |
| A2 | 900 | 97 | Bainite | 1127 | 1587 | 7.4 | 116 | X | Comparative |
| | | | | | | | | | Material 1 |
| B2 | 900 | 97 | Bainite | 1136 | 1578 | 7.3 | 121 | X | Comparative |
| | | | | | | | | | Material 2 |
| C2 | 900 | 98 | Bainite | 1167 | 1598 | 7.4 | 146 | X | Comparative |
| | | | | | | | | | Material 3 |
| D2 | 800 | 86 | Ferrite | 806 | 1337 | 4.8 | 30 | Δ | Comparative |
| | | | | | | | | | Material 4 |
| D2 | 900 | 96 | Bainite | 1017 | 1506 | 7.6 | 55 | X | Comparative |
| | | | | | | | | | Material 5 |
| E2 | 800 | 75 | Ferrite | 947 | 1150 | 6.8 | 81 | Δ | Comparative |
| | | | | | | | | | Material 6 |
| E2 | 900 | 78 | Ferrite | 950 | 1185 | 7.3 | 22 | X | Comparative |
| | | | | | | | | | Material 7 |

(1) ◯: Excellent, Δ: Inferior, X: Poor

As can be seen from the data shown in Tables 4 and 5, Inventive Materials 1-6, which satisfied the steel composition and were manufactured under the production conditions defined in the present invention, showed an ultra-high tensile strength higher than 1,470 MPa. Further, the yield strength variations of the final products before and after painting simulation at 170° C. for 20 minutes were higher than 100 MPa, which indicates that the final products can be used as structural parts and reinforcements of automobile bodies with excellent impact properties. Moreover, the final products showed good adhesion to the corresponding coating layers.

In contrast, Comparative Materials 1-3, 5, and 7, which did not satisfy the heat treatment conditions of hot press forming defined in the present invention and were manufactured by hot press forming at a high temperature shows poor adhesion to the corresponding coating layers.

Particularly, Comparative Material 4 manufactured using Comparative Steel D whose Mn and N contents were out of the respective ranges defined in the present invention did not attain the desired fraction of martensite and showed a slight increment in tensile strength and yield strength. Comparative Material 5 manufactured using Comparative Steel D2 by high-temperature treatment attained the desired strength and showed poor adhesion to the coating layer.

Further, since Comparative Materials 6 and 7 manufactured using Comparative Steel E2 whose C and N contents were out of the respective ranges defined in the present invention did not attain a sufficient martensitic structure after heat treatment and processing in the mold due to their low carbon content, they did not show a high tensile strength. Moreover, Comparative Materials 6 and 7 showed a slight increment in yield strength due to their low nitrogen content.

### Example 3

First, steel slabs having the compositions indicated in Table 6 were prepared. The steel slabs were dissolved under vacuum and reheated in a heating furnace at a temperature of 1,150° C. to 1,250° C. for one hour, hot-rolled, and coiled. The hot rolling was finished at a temperature of 850° C. to 950° C., and the coiling was conducted at 650° C. The hot-rolled steel sheets were pickled and cold-rolled at a reduction rate of 50%. The cold-rolled steel sheets were annealed at 800° C. and continuously annealed at an overaging temperature of 400° C.

The cold-rolled steel sheets were Al-coated by the following procedure. The cold-rolled steel sheets were degreased, pretreated, preheated in a non-oxidizing heating furnace at 700° C., and heat-treated in a reducing atmosphere of nitrogen and hydrogen. At this time, the heat treatment was conducted at a maximum temperature of 820° C. The heat-treated steel sheets were cooled and immersed in a coating solution at 680° C. The coating solution was composed of 8.5% of Si, 2.4% of Fe and the balance Al. To form a coating layer to a thickness of 25□ to 30□ per side, gas wiping was performed on the steel sheets. Thereafter, a spangle controller was operated to adjust the surface spangle of the Al-coated steel sheets to zero.

The coated cold-rolled steel sheets were heat-treated at a high temperature by heating the steel sheets to 800° C. to 950° C. at a rate of 10° C./sec, further heating the steel sheets in the temperature range for 5 minutes, transferring the hot steel sheets into a mold, and processing the hot steel sheets in the mold. Immediately after completion of the processing, the resulting steel sheets were rapidly cooled at a rate of −80° C./sec. Then, the heat-treated steel sheets were cut into JIS #5 tensile test pieces. The test pieces were boiled in an oil at 170° C. for 20 minutes to simulate the quality of painted structural parts for use in automobiles manufactured using the test pieces. Thereafter, a tensile test on the painted test pieces was conducted using a universal tensile testing machine.

To evaluate the corrosion resistance of the high-temperature treated test pieces after painting, the Al-coated steel sheets were heated to 800° C. to 900° C. for 5 minutes and cooled with water. Phosphate treatment and cationic electrodeposition painting were conducted, and then the painted steel sheets were cross-cut to a predetermined depth. After a combination of a salt spray test and a cyclic corrosion test, which required 8 hours per cycle, was conducted, the width of blisters formed in the painted steel sheets was measured to evaluate the corrosion resistance of the painted steel sheets.

TABLE 6

| | Chemical components (wt %) | | | | | | | | | |
|---|---|---|---|---|---|---|---|---|---|---|
| Steel | C | Si | Mn | P | S | Al | N | W | Others | Remarks |
| A3 | 0.24 | 0.28 | 1.07 | 0.012 | 0.002 | 0.036 | 0.03 | 0.051 | B: 0.0018 | Inventive |
| | | | | | | | | | Ti: 0.023 | steel |
| B3 | 0.23 | 0.26 | 1.02 | 0.012 | 0.002 | 0.021 | 0.03 | 0.050 | B: 0.0020, | Inventive |
| | | | | | | | | | Mo: 0.05 | steel |
| C3 | 0.24 | 0.28 | 1.07 | 0.012 | 0.002 | 0.036 | 0.0172 | 0.051 | B: 0.0018 | Inventive |
| | | | | | | | | | | steel |
| D3 | 0.23 | 0.26 | 1.02 | 0.012 | 0.002 | 0.021 | 0.0136 | 0.050 | B: 0.0020 | Inventive |
| | | | | | | | | | Cr: 0.06, | steel |
| | | | | | | | | | Mo: 0.05 | |
| E3 | 0.22 | 0.27 | 2.37 | 0.012 | 0.002 | 0.042 | 0.0160 | 0.050 | Ti: 0.023, | Inventive |
| | | | | | | | | | V: 0.03 | steel |
| F3 | 0.31 | 0.62 | 0.72 | 0.013 | 0.002 | 0.044 | 0.0140 | 0.023 | B: 0.0011 | Inventive |
| | | | | | | | | | Cr: 1.19, | steel |
| | | | | | | | | | Mo: 0.67 | |
| | | | | | | | | | Ni: 0.06 | |
| G3 | 0.23 | 0.22 | 1.23 | 0.011 | 0.003 | 0.050 | 0.0154 | 0.185 | B: 0.0018 | Inventive |
| | | | | | | | | | Nb: 0.02 | steel |
| | | | | | | | | | Cu: 0.05 | |
| H3 | 0.27 | 0.15 | 1.36 | 0.015 | 0.006 | 0.067 | 0.0115 | 0.035 | — | Inventive |
| | | | | | | | | | | steel |
| I3 | 0.062 | 0.112 | 2.519 | 0.011 | 0.002 | 0.036 | 0.004 | 0.021 | Cr: 1.01 | Comparative |
| | | | | | | | | | | steel |
| J3 | 0.065 | 0.125 | 3.015 | 0.012 | 0.002 | 0.0254 | 0.004 | — | B: 0.0005 | Comparative |
| | | | | | | | | | Cr: 0.97 | steel |
| K3 | 0.150 | 0.229 | 2.504 | 0.011 | 0.003 | 0.040 | 0.004 | — | B: 0.0018 | Comparative |
| | | | | | | | | | Cr: 0.2 | steel |
| | | | | | | | | | Ti: 0.02 | |

TABLE 7

| | microstructure of hot- | | | | | | |
|---|---|---|---|---|---|---|---|
| | pressed parts | | Mechanical properties | | | | |
| | Fraction of- | Other | YS | TS | El | ΔYS | |
| Steel | martensite | structures | (MPa) | (MPa) | (%) | (MPs) | Remarks |
| A3 | 99 | Bainite | 982 | 1492 | 7.9 | 186 | Inventive steel |
| B3 | 99 | Bainite | 1035 | 1521 | 7.4 | 175 | Inventive steel |
| C3 | 99 | Bainite | 982 | 1492 | 7.9 | 186 | Inventive steel |
| D3 | 99 | Bainite | 1035 | 1521 | 7.4 | 175 | Inventive steel |
| E3 | 99 | Bainite | 1125 | 1598 | 5.3 | 145 | Inventive steel |
| F3 | 100 | — | 1215 | 1798 | 6.5 | 125 | Inventive steel |
| G3 | 99 | Bainite | 1105 | 1511 | 6.5 | 144 | Inventive steel |
| H3 | 98 | Bainite | 1026 | 1512 | 7.2 | 106 | Inventive steel |
| I3 | 35 | Ferrite, | 925 | 1178 | 7.4 | 41 | Comparative steel |
| | | Bainite | | | | | |
| J3 | 32 | Ferrite, | 915 | 1145 | 6.2 | 36 | Comparative steel |
| | | Bainite | | | | | |
| K3 | 73 | Bainite | 1036 | 1518 | 3.4 | 35 | Comparative steel |

ΔYS: variation in yield strength before and after painting

The results of Table 7 demonstrate that the hot-pressed parts manufactured using the respective Inventive Steels A3-H3 satisfying the steel composition defined in the present invention showed an ultra-high tensile strength higher than 1,470 MPa. Further, since the steel sheets were processed in a hot state, products having a complicated shape could also be processed. Moreover, the yield strength variations of the hot-pressed parts before and after painting simulation at 170° C. for 20 minutes were higher than 120 MPa, which indicates that the hot-pressed parts can be used as structural parts and reinforcements of automobile bodies with excellent impact properties.

In contrast, since the hot-pressed parts manufactured using the respective Comparative Steels 13-J3 did not attain a sufficient martensitic structure after heat treatment and mold processing in the mold due to their low carbon content, they did not show a high tensile strength and a slight increment in yield strength after the painting. Moreover, the hot-pressed part manufactured using Comparative Steel K3 attained a sufficiently high tensile strength but showed a slight increment in yield strength.

TABLE 8

| | | | | Corrosion | Composition | |
|---|---|---|---|---|---|---|
| | Coating | | Adhesion | resistance | of surface | |
| | weight | Surface | to coating | after | layer (%) | |
| Steel | (g/m²) | appearance | layer | painting | Si | Fe |
| A3 | 20 | ◯ | ◯ | Δ | 8.5 | 42.9 |
| A3 | 40 | ⊚ | ⊚ | ⊚ | 7.2 | 50.1 |
| A3 | 50 | ⊚ | ⊚ | ⊚ | 7.0 | 50.8 |
| A3 | 60 | ⊚ | ⊚ | ⊚ | 6.4 | 40.4 |
| A3 | 80 | ⊚ | ⊚ | ⊚ | 6.6 | 40.2 |
| A3 | 100 | ⊚ | Δ | Δ | 4.1 | 30.3 |
| B3 | 20 | ◯ | Δ | Δ | 8.8 | 38.7 |
| B3 | 40 | ⊚ | ⊚ | ⊚ | 8.0 | 54.4 |
| B3 | 50 | ⊚ | ⊚ | ⊚ | 7.8 | 52.2 |
| B3 | 60 | ⊚ | ⊚ | ⊚ | 6.9 | 48.3 |
| B3 | 80 | ⊚ | ⊚ | ⊚ | 5.9 | 44.1 |
| B3 | 100 | ◯ | Δ | Δ | 4.4 | 29.9 |
| C3 | 50 | ⊚ | ⊚ | ⊚ | 7.0 | 47.8 |
| D3 | 40 | ⊚ | ⊚ | ⊚ | 7.2 | 50.1 |
| E3 | 50 | ⊚ | ⊚ | ⊚ | 7.0 | 50.8 |
| F3 | 40 | ⊚ | ⊚ | ⊚ | 8.0 | 54.4 |
| G3 | 60 | ⊚ | ⊚ | ⊚ | 6.4 | 40.4 |
| H3 | 50 | ⊚ | ⊚ | ⊚ | 7.0 | 52.4 |

As apparent from the results of Table 8, when Inventive Steels A3-H3 were coated in an amount of 40 g/m² or less, the steel crystals became indistinct after the phosphate treatment and the corrosion resistance was deteriorated due to high Si content of the respective surface layers. In addition, when Inventive Steels A3-H3 were coated in an amount of 80 g/m² or more, they had good surface appearance, but showed poor adhesion to the respective coating layers and poor corrosion resistance after the painting due to low Si content of the respective surface layers.

The present invention has been described herein with reference to the foregoing embodiments. These embodiments do not serve to limit the scope of the present invention. All modifications having substantially the same constitution, operation and effects as the technical spirit of the present invention as disclosed in the accompanying claims are intended to come within the scope of the present invention.

1. A steel sheet with excellent heat treatment and impact properties which has a composition comprising 0.1% to 0.5% by weight of carbon (C), 0.01% to 1.0% by weight of silicon (Si), 0.5% to 4.0% by weight of manganese (Mn), 0.1% by weight or less of phosphorus (P), 0.03% by weight or less of sulfur (S), 0.1% by weight of soluble aluminum (Al), 0.01% to 0.1% by weight of nitrogen (N), 0.3% by weight or less of tungsten (W), and the balance iron (Fe) and other inevitable impurities.

2. The steel sheet according to claim 1, wherein the steel sheet is a hot-rolled steel sheet, a cold-rolled steel sheet, or a steel sheet having a layer coated with aluminum, galvanized layer or galvannealed layer.

3. The steel sheet according to claim 2, wherein the steel sheet has a layer coated with aluminum which contains Si, in a coating weight of 40 to 80 g/m² per side.

4. The steel sheet according to claim 1, wherein the steel sheet has a galvanized layer or a galvannealed layer and contains 1.0 to 4.0% by weight of Mn.

5. The steel sheet according to any one of claims 1 to 4, wherein the composition of the steel sheet further comprises at least one element selected from the group consisting of:
a) at least one element selected from Mo and Cr in an amount of 0.01% to 2.0% by weight;
b) at least one element selected from Ti, Nb and V in an amount of 0.001% to 0.1% by weight;
c) at least one element selected from Cu in an amount of 0.005% to 1.0% by weight and Ni in an amount of 0.005% to 2.0% by weight; and
d) B in an amount of 0.0001% to 0.01% by weight.

6. A method for producing a steel sheet with excellent heat treatment and impact properties, comprising:
reheating a steel slab, which has a composition comprising 0.1% to 0.5% by weight of C, 0.01% to 1.0% by weight of Si, 1.0% to 4.0% by weight of Mn, 0.1% by weight or less of P, 0.03% by weight or less of S, 0.1% by weight of soluble Al, 0.01% to 0.1% by weight of N, 0.3% by weight or less of W and the balance Fe and other inevitable impurities, to 1,100° C. to 1,300° C., subjecting the reheated steel slab to hot finish rolling at a temperature not lower than the Ar₃ transformation point but not higher than 1,000° C., and coiling the hot-rolled steel sheet at 500° C. to 750° C.;
pickling the coiled hot-rolled steel sheet and cold rolling the pickled hot-rolled steel sheet; and
hot-dip galvanizing the cold-rolled steel sheet in the temperature range of 450° C. to 500° C. for 10 seconds or less.

7. The method according to claim 6, further comprising alloying the galvanized cold-rolled steel sheet in the temperature range of 440° C. to 580° C. for 30 seconds or less after the galvanization.

8. The method according to claim 6, further comprising continuously annealing the cold-rolled steel sheet at a temperature of 750° C. to 900° C. prior to the hot-dip galvanization.

9. The method according to any one of claims 6 to 8, wherein the composition of the steel slab further comprises at least one element selected from the group consisting of:
a) at least one element selected from Mo and Cr in an amount of 0.01% to 2.0% by weight;
b) at least one element selected from Ti, Nb and V in an amount of 0.001% to 0.1% by weight;
c) at least one element selected from Cu in an amount of 0.005% to 1.0% by weight and Ni in an amount of 0.005% to 2.0% by weight; and
d) B in an amount of 0.0001% to 0.01% by weight.

10. A hot-pressed part with excellent heat treatment and impact properties which has a steel microstructure composed of 80% or more of a martensitic structure and has the steel composition defined in claim 1.

11. The hot-pressed part according to claim 10, wherein the part has a layer coated with aluminum, galvanized layer or galvannealed layer.

12. The hot-pressed part according to claim 11, wherein the aluminum coating layer contains 4.5% to 8.4% of Si, 39% to 55% of Fe and the balance Al.

13. The hot-pressed part according to claim 10, wherein the part has a yield strength variation(ΔYS) of 100 MPa or more before and after painting.

14. The hot-pressed part according to any one of claims 10 to 13, wherein the steel composition further comprises at least one element selected from the group consisting of:
a) at least one element selected from Mo and Cr in an amount of 0.01% to 2.0% by weight;
b) at least one element selected from Ti, Nb and V in an amount of 0.001% to 0.1% by weight;
c) at least one element selected from Cu in an amount of 0.005% to 1.0% by weight and Ni in an amount of 0.005% to 2.0% by weight; and
d) B in an amount of 0.0001% to 0.01% by weight.

15. A method for manufacturing a hot-pressed part with excellent heat treatment and impact properties by hot-press forming the steel sheet according to claim 1 and rapidly cooling the hot-pressed steel sheet at a rate of 10° C./sec to 500° C./sec to allow the steel sheet to have a martensitic structure fraction of 80% or more.

16. The method according to claim 15, wherein the steel sheet is a hot-rolled steel sheet, a cold-rolled steel sheet or an aluminum-coated steel sheet; and the hot press forming is performed by heating the steel sheet in the temperature range of 800° C. to 1,000° C. at a rate of 1° C./sec to 100° C./sec and forming the hot steel sheet while maintaining the temperature range for 10 to 1,000 seconds.

17. The method according to claim 15, wherein the aluminum-coated steel sheet has a layer coated with aluminum which contains Si, in a coating weight of 40 to 80 g/m² per side.

18. The method according to claim 15, wherein the steel sheet has a layer coated with galvanized layer or galvannealed layer formed on the surface and contains 1.0 to 4.0% by weight of Mn; and the hot press forming is performed by heating the steel sheet in the temperature range of 700° C. to 850° C. at a rate of 1° C./sec to 100° C./sec and forming the hot steel sheet while maintaining the temperature range for 10 to 1,000 seconds.

19. The method according to claim 18, wherein the zinc coating is performed by hot-dip galvanizing the cold-rolled steel sheet in the temperature range of 450° C. to 500° C. for 10 seconds or less.

20. The method according to claim 18, wherein the galvannealed layer is performed by hot-dip galvanizing the cold-rolled steel sheet in the temperature range of 450° C. to 500° C. for 10 seconds or less and alloying the galvanized cold-rolled steel sheet in the temperature range of 440° C. to 580° C. for 30 seconds or less.

21. The method according to claim 15, wherein the method comprises:
reheating a steel slab to 1,100° C. to 1,300° C., subjecting the reheated steel slab to hot finish rolling at a temperature not lower than the Ar₃ transformation point but not higher than 1,000° C., and coiling the hot-rolled steel sheet at 500° C. to 750° C.; and
pickling the coiled hot-rolled steel sheet and cold rolling the pickled hot-rolled steel sheet.

22. The method according to claim 21, further comprising continuously annealing the cold-rolled steel sheet at 700° C. to 900° C.

23. The method according to any one of claims 15 to 22, wherein the composition of the steel sheet further comprises at least one element selected from the group consisting of:
a) at least one element selected from Mo and Cr in an amount of 0.01% to 2.0% by weight;
b) at least one element selected from Ti, Nb and V in an amount of 0.001% to 0.1% by weight;
c) at least one element selected from Cu in an amount of 0.005% to 1.0% by weight and Ni in an amount of 0.005% to 2.0% by weight; and
d) B in an amount of 0.0001% to 0.01% by weight.
